(19) United States
(12) Patent Application Publication
(10) Pub. No.: US 2014/0256292 A1
(43) Pub. Date: Sep. 11, 2014

(54) METHOD OF PROCESSING MESSAGE AND APPARATUS USING THE METHOD

(71) Applicant: Samsung Electronics Co., Ltd., Suwon-si (KR)

(72) Inventor: Tae-Hwan SON, Suwon-si (KR)

(73) Assignee: Samsung Electronics Co., Ltd., Suwon-si (KR)

(21) Appl. No.: 14/199,123

(22) Filed: Mar. 6, 2014

(30) Foreign Application Priority Data
Mar. 6, 2013 (KR) 10-2013-0023876

(51) Int. Cl. H04W 4/14; H04W 4/02

(52) U.S. Cl. CPC H04W 4/14; H04W 4/025
USPC 455/412.1

(57) ABSTRACT

A method of processing a text message in a terminal includes receiving a text message, identifying position information of the terminal in response to the receiving of the text message, and configuring message data including the text message and the position information and storing the message data.

### CROSS-REFERENCE TO RELATED APPLICATION(S)

This application claims the benefit under 35 U.S.C. §119(a) of a Korean patent application filed on Mar. 6, 2013 in the Korean Intellectual Property Office and assigned Serial No. 10-2013-0023876, the entire disclosure of which is hereby incorporated by reference.

### TECHNICAL FIELD

The present disclosure relates to a portable terminal. More particularly, the present disclosure relates to a method and an apparatus for processing a message transceived in a portable terminal.

### BACKGROUND

Recently, various services and additional functions provided in a mobile device have been greatly expanded. In order to improve value of a mobile device and satisfy various user requirements, various applications executable in a mobile device have been developed.

Basic applications manufactured and installed by a manufacturing company of a corresponding device, and additional applications downloaded from a commercial vendor may be stored and executed in a mobile device. The additional applications may be developed by third party developers and be registered in the commercial vendor. Accordingly, anybody may freely sell developed applications to a user of the mobile device through the commercial vendor. Accordingly, currently, tens of thousands to hundreds of thousands of applications are provided to the mobile device free of charge or for a fee.

Accordingly, at least several applications are stored in a recent mobile device, such as a smart phone and a tablet Personal Computer (PC), and shortcut keys for executing the respective applications are displayed on a touch screen of a mobile device. Accordingly, a user may execute a desired application in the mobile device by touching any one of icons displayed on the touch screen.

In the meantime, as the mobile device has been widely used, a user sends and receives a large number of messages with another user. In particular, financial companies, such as a credit card company, provide a mobile device with a change in financial information, such as credit card use details, in real time in order to provide convenience to customers.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for storing position information in connection with a transceived message and effectively utilizing the stored position information.

Another aspect of the present disclosure is to provide a method and an apparatus for providing a user with position information at a time at which a message is transceived.

Another aspect of the present disclosure is to provide a method and an apparatus for permitting a user to more intuitively identify special information by matching position information of a received message to a map for the purpose of providing the special information.

In accordance with an aspect of the present disclosure, a method of processing a text message in a terminal is provided. The method includes receiving a text message, identifying position information of a terminal in response to the receiving of the text message, and configuring message data including the text message and the position information and storing the message data.

Further, the method may further include displaying map data with a position identifier indicating a position corresponding to the position information and with content of the text message.

In accordance with another aspect of the present disclosure, a terminal device is provided. The terminal device includes a display, an input interface, a GPS receiver, a communication unit, a controller configured to execute one or more program modules, and a memory unit that stores the one or more program modules, wherein the one or more program modules process a text message received through the communication unit, identify position information of a terminal in response to the receiving of the text message, and configure message data including the text message and the position information and store the configured message data in the memory unit.

Further, the one or more program modules further display map data on the display with a position identifier indicating a position corresponding to the position information and content of the text message corresponding to the position identifier.

In accordance with another aspect of the present disclosure, a non-transitory computer-readable storage medium for storing instructions that, when executed, cause at least one processor to process a text message received through a communication unit, identify position information of a terminal in response to the receiving of the text message, and configure message data including the text message and the position information and store the configured message data in a memory unit.

Further, the non-transitory computer readable medium further display map data on a display with a position identifier indicating a position corresponding to the position information and content of the text message corresponding to the position identifier.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a portable terminal according to an embodiment of the present disclosure;

FIG. 2 is a front perspective view of the portable terminal according to an embodiment of the present disclosure;

FIG. 3 is a flowchart illustrating a message processing method according to an embodiment of the present disclosure;

FIG. 4 is a diagram illustrating an example of a message data format stored by the message processing method according to an embodiment of the present disclosure;

FIGS. 5A, 5B, 5C, 5D, 5E, 5F, 5G, 5H, 5I, 5J, and 5K are diagrams illustrating examples of a user interface provided by the message processing method according to an embodiment of the present disclosure; and

FIGS. 6A and 6B are diagrams illustrating another example of a user interface provided by the message processing method according to the embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

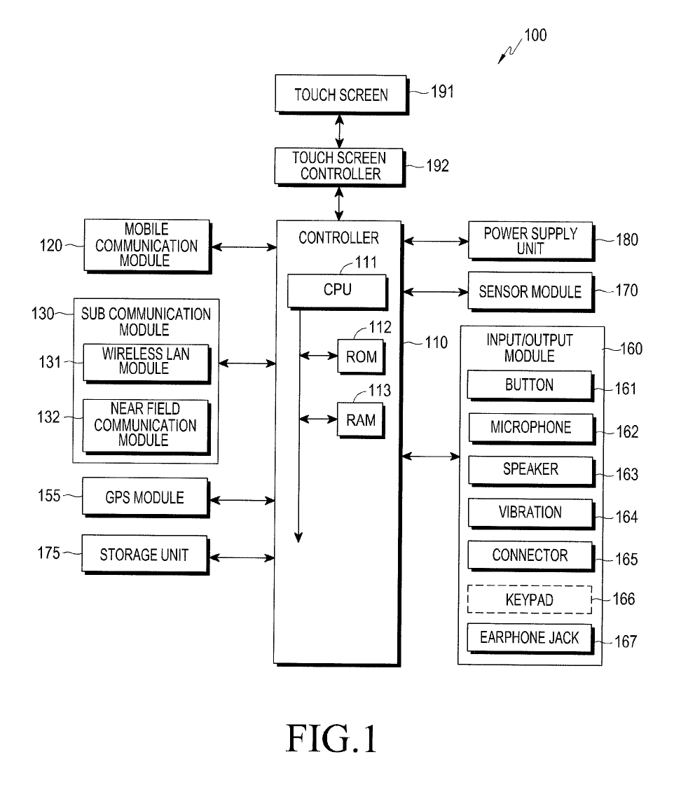

FIG. 1 is a block diagram of a portable terminal according to an embodiment of the present disclosure.

Referring to FIG. 1, an apparatus 100 may be connected with an external device (not shown) by using an external device connection unit, such as a sub communication module 130, a connector 165, and an earphone jack 167. The external device may include various devices, such as an earphone, an external speaker, a Universal Serial Bus (USB) memory, a charger, a cradle/dock, a Digital Multimedia Broadcasting (DMB) antenna, a mobile payment related device, a health management device (e.g., a blood-sugar testing device), a game input device, and a vehicle navigation device that are detachable and/or connected to the apparatus 100. Further, the external device may include a near field communication device, such as a Bluetooth communication device and a Near Field Communication (NFC) device, that is wirelessly connectable to the device 100 by near field communication, a Wireless Fidelity (Wi-Fi) direct communication device, and a wireless Access Point (AP). Further, the external device may include another device, a portable phone, a smart phone, a tablet Personal Computer (PC), a desktop PC, and a server.

Referring to FIG. 1, the apparatus 100 includes a touch screen display 191 and a touch screen controller 192. Further, the apparatus 100 includes a controller 110, a mobile communication module 120, a sub communication module 130, a GPS module 155, an input/output module 160, a sensor module 170, a storage unit 175, and a power supply unit 180. The sub communication module 130 includes at least one of a wireless Local Access Network (LAN) module 131 and a near field communication module 132. The input/output module 160 includes at least one of a button 161, a microphone 162, a speaker 163, a vibration motor 164, a connector 165, and a keypad 166.

The controller 110 may include a Central Processing Unit (CPU) 111, a Read Only Memory (ROM) 112 for storing a control program for controlling the device 100, and a Random Access Memory (RAM) 113 for storing a signal or data input from external sources or used as a storage area for the device 100. The CPU 111, the ROM 112, and the RAM 113 may be connected with each other through an internal bus.

The controller 110 may control the mobile communication module 120, the sub communication module 130, the GPS module 155, the input/output module 160, the sensor module 170, the storage unit 175, the power supply unit 180, the touch screen display 191, and a touch screen controller 192.

Further, the controller 110 may have one or more processing cores.

The mobile communication module 120 permits the apparatus 100 to be connected with an external device through mobile communication by using at least one or more antennas (not shown) according to the control of the controller 110. The mobile communication module 120 transceives a wireless signal for a voice call, a video call, a Short Message Service (SMS), or a Multimedia Messaging Service (MMS) with another device such as a portable phone (not shown) having an input telephone number, a smart phone (not shown), a tablet PC, or another device (not shown). Further, the mobile communication module 120 may drive a Local Positioning System (LPS) for identifying position information of a terminal through communication with a base station adjacent to the apparatus 100.

The sub communication module 130 may include at least one of the wireless LAN module 131 and the near field communication module 132. For example, the sub communication module 130 may include only the wireless LAN module 131, only the near field communication module 132, or both the wireless LAN module 131 and the near field communication module 132.

The wireless LAN module 131 may be connected to the Internet at a location where a wireless AP (not shown) is installed. The wireless LAN module 131 supports at least one wireless LAN standard of the Institute of Electrical and Electronics Engineers (IEEE) such as IEEE 802.11x. The wireless LAN module 131 may drive a Wi-Fi Positioning System (WPS) that identifies position information of the wireless LAN module 131 by using position information provided by the wireless AP.

The near field communication module 132 may wirelessly establish near field communication between the apparatus 100 and an image forming device (not shown). The near field communication method may include Bluetooth, Infrared Data Association (IrDA), WiFi-Direct communication, Near Field Communication (NFC), and the like.

The apparatus 100 may include at least one of the mobile communication module 120, the wireless LAN module 131, and the near field communication module 132. For example, the apparatus 100 may include one or more of the mobile communication module 120, the wireless LAN module 131, and the near field communication module 132.

The GPS module 155 may receive signals from a plurality of GPS satellites (not shown) in orbit around the Earth, and calculate a position of the apparatus 100 by using a time of arrival of the signals from the GPS satellites (not shown) at the apparatus 100.

The input/output module 160 may include at one or more of the button 161, the microphone 162, the speaker 163, the vibration motor 164, the connector 165, and the keypad 166.

The button 161 may be formed in a front surface, a side surface, or a rear surface of a housing of the apparatus 100, and may include at least one of a power/lock button (not shown), a volume button (not shown), a menu button, a home button, a back button, and a search button.

The microphone 162 generates an electrical signal by receiving a voice or a sound according to the control of the control unit 110.

The speaker 163 may output sound corresponding to various signals (for example, a wireless signal, a broadcasting signal, a digital audio file, a digital video file, or a photographing) of the mobile communication module 120, the sub communication module 130, the multimedia module 140, or the camera module 150. The speaker 163 may output a sound (for example, a button operation sound or a call connection sound corresponding to a telephone call) corresponding to a function performed by the apparatus 100. One or more speakers 163 may be formed at an appropriate position or positions of the housing of the apparatus 100.

The vibration motor 164 may convert an electrical signal to a mechanical vibration according to the control of the controller 110. For example, in a case where the apparatus 100 in a vibration mode receives a voice call from another device (not shown), the vibration motor 164 is operated. One or more vibration motors 164 may be formed inside the housing of the apparatus 100. The vibration motor 164 may be operated in response to a user touching the touch screen display 191.

The connector 165 may be used as an interface for connecting the apparatus 100 and an external device (not shown) or a power source (not shown). The apparatus 100 may transmit data stored in the storage unit 175 of the apparatus 100 to an external device (not shown) or receive data from an external device (not shown). Further, the apparatus 100 may receive power from a power source (not shown) through the wired cable connected to the connector 165, or charge a battery (not shown) by using the power source.

The keypad 166 may receive a key input from the user for the control of the apparatus 100. The keypad 166 includes a physical keypad (not shown) provided on a surface of the apparatus 100 or a virtual keypad (not shown) displayed on the touch screen display 191. The physical keypad (not shown) provided at the apparatus 100 may not be necessary to include on the apparatus 100. Further, the physical keypad (not shown) may be connected to the apparatus through a connector 165 and the sub communication module 130.

The earphone connecting jack 167 may receive an earphone plug of an earphone (not shown) to be connected to the apparatus 100.

The sensor module 170 includes at least one sensor for detecting a state of the apparatus 100. For example, the sensor module 170 may include a proximity sensor (not shown) for detecting whether the user approaches the apparatus 100, an illumination sensor (not shown) for detecting a quantity of light around the apparatus 100, or a motion sensor (not shown) for detecting a motion (for example, a rotation, acceleration, or vibration) of the apparatus 100, a geo-magnetic sensor (not shown) for detecting an orientation of the apparatus using the earth's magnetic field, a gravity sensor for detecting gravity, and an altimeter for detecting an altitude by measuring pressure of the atmosphere. At least one sensor may detect an environmental condition, generate a signal corresponding to the detected condition, and transmit the generated signal to the controller 110. The sensor of the sensor module 170 may be added or removed according to the apparatus 100.

The storage unit 175 may store an input/output signal or data based on the operation of the mobile communication module 120, the sub communication module 130, the GPS module 155, the input/output module 160, the sensor module 170, and the touch screen display 191. The storage unit 175 may store a control program and applications for the control of the apparatus 100 or the controller 110.

The term storage unit includes the storage unit 175, the ROM 112 within the controller 110, the RAM 113, or a memory card (not shown) such as an SD card and a memory stick connected to the apparatus 100. The storage unit may include a non-volatile memory, a volatile memory, a Hard Disk Drive (HDD), or a Solid State Drive (SSD).

The power supply unit 180 may supply power to one or more batteries (not shown) disposed in the housing of the apparatus 100. One or more batteries (not shown) supply power to the apparatus 100. Further, the power supply unit 180 may supply power input from an external power source (not shown) to the apparatus 100. Further, the power supply unit 180 may also supply power from an external power source to the apparatus through a wireless charging technique.

The touch screen display 191 may display user interfaces corresponding to various services (for example, a call, data transmission, broadcasting, and photographing) to the user based on an Operation System (OS). The touch screen display 191 may transmit an analog signal corresponding to a touch input to the touch screen controller 192. The touch screen display 191 may receive the touch input through a body of the user (for example, a finger) or an input device (for example, a stylus pen) capable of performing a touch input. Further, the touch screen display 191 may receive a successive motion of touches. The touch screen display 191 may transmit an analog signal corresponding to input successive motion of the touches to the touch screen controller 192.

The touch screen display 191 may be implemented by, for example, a resistive method, a capacitive method, an infrared method, or an acoustic wave method.

In the meantime, the touch screen controller 192 controls an output value of the touch screen display 191 to display data provided by the controller 110 on the touch screen display 191. Further, the touch screen controller 192 converts an analog signal received from the touch screen display 191 to a digital signal (for example, X and Y coordinates) and transmits the converted digital signal to the controller 110. The controller 110 may control the touch screen display 191 by using a digital signal received from the touch screen controller 192. For example, the controller 110 may cause a shortcut icon (not shown) displayed on the touch screen display 191 to be selected or to execute an application associated with the shortcut icon (not shown) in response to a touch event or a hovering event. Further, the touch screen controller 192 may be included in the controller 110.

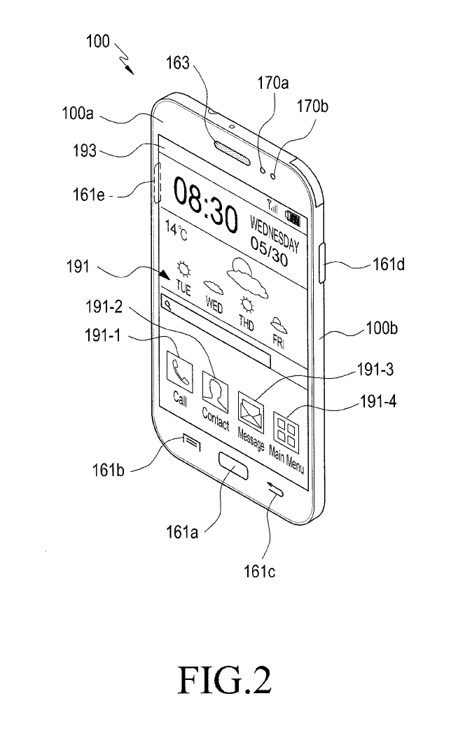

FIG. 2 is a front perspective view of the portable terminal according to an embodiment of the present disclosure.

Referring to FIG. 2, the touch screen display 191 is disposed at a center of a front surface 100a of the apparatus 100. The touch screen display 191 is formed to occupy most of the front surface 100a of the apparatus 100. FIG. 2 illustrates an example in which a main home screen is displayed on the touch screen display 191. The main home screen is a first image displayed on the touch screen display 191 when the apparatus 100 is turned on. Further, when the apparatus has several different home screens of several pages, the main home screen may be the first home screen among the home screens of the several pages. Shortcut icons 191-1, 191-2, and 191-3, a main menu change key 191-4, a time, weather, and the like for executing frequently used applications may be displayed on the main screen. The main menu change key 191-4 displays a menu image on the touch screen display 191. Further, a status bar 193 displaying a state of the apparatus 100, such as a charging state of a battery, an intensity of a received signal, and a current time may be formed at an upper end of the touch screen display 191.

A home button 161a, a menu button 162b, and a back button 161c may be formed in a lower portion of the touch screen display 191. A power/reset button 161d, a volume button 161e, and the like may be disposed in a side surface 100b of the apparatus 100.

The home button 161a displays the main home screen on the touch screen display. For example, when the home button 161a is input while displaying another home screen or the menu image on the touch screen display 191, the main home screen may be displayed on the touch screen display 191. Further, when the home button 191a is touched during the execution of the applications on the touch screen display 191, the main home screen illustrated in FIG. 2 may be displayed on the touch screen display 191. Further, the home button 161a may be used to display recently used applications or display a task manager on the touch screen display 191.

The menu button 161b provides a connection menu usable on the touch screen display 191. The connection menu may include a widget addition menu item, a background image change item, a search menu item, an edition menu item, an environment setting menu item, and the like. Further, the menu button 161b may provide a menu item, such as search, edition, deletion, storage, and environment configuration, provided by the application in a state where an application is currently executed.

The back button 161c may display an image executed just before a currently executed image or terminate the most recently used application.

An illumination sensor 170a and a proximity sensor 170b may be disposed at an edge of the front surface 100a of the apparatus 100.

Further, a connector (not shown) may be formed at a side surface of the lower end of the apparatus 100 that is provided with a plurality of electrodes and may be electrically connected with an external device. An earphone jack 167 in which the earphone may be inserted may be formed in a side surface of an upper end of the apparatus 100.

Hereinafter, the methods according to the various embodiments of the present disclosure may be implemented in a program command form executable by various computer components and recorded in a computer readable medium. The computer readable medium may include one or a combination of a program command, a data file, and a data structure. The program command recorded in the medium may be specially designed and configured for the present disclosure.

Further, the methods according to the various embodiments of the present disclosure may be implemented and stored in a software module in the storage unit 175 of the apparatus 100, and the software module may be temporarily stored in the RAM 113 to execute the methods according to the various embodiments of the present disclosure. Accordingly, the controller 110 may perform a control of hardware included in the apparatus 100 according to the software module, temporarily or continuously store data generated in the storage unit 175 while executing the software module, and provide a UI to the touch screen controller 192.

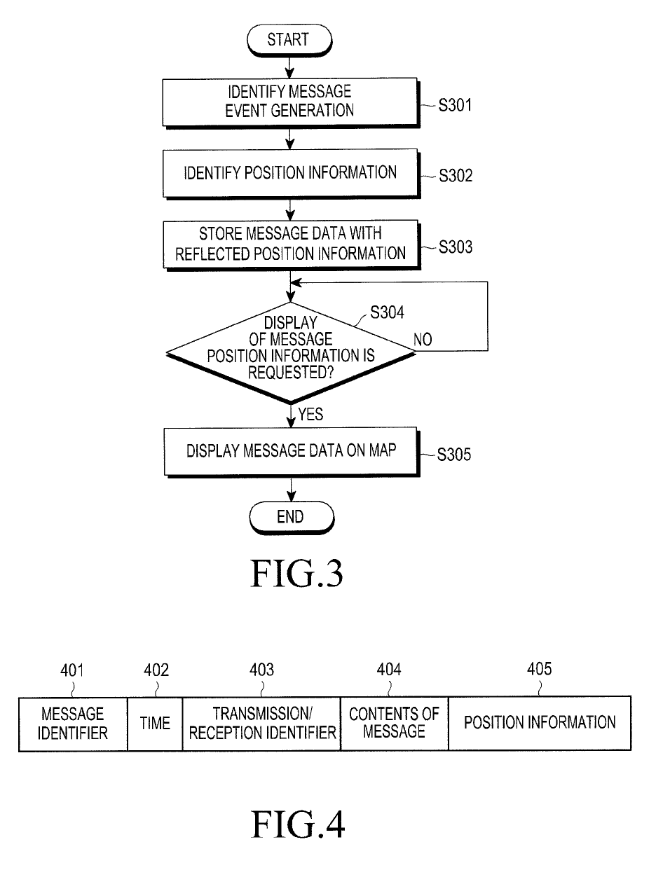

FIG. 3 is a flowchart illustrating a message processing method according to an embodiment of the present disclosure.

Referring to FIG. 3, the message processing method according to the embodiment of the present disclosure includes identifying a message event at operation S301, identifying position information at operation S302, and storing message data to which the position information is reflected at operation S303.

The identifying of the message event at operation S301 identifies generation of a message transmission event and a message reception event. That is, message application is initiated by the user, an input for generating the message, for example, a selection of a message generation menu item, is generated, and then the generation of the message transmission event is identified according to the identification of the input for transmitting the message. Further, the generation of the message reception event is identified according to the reception of the message through the mobile communication module, and the like.

In the embodiment of the present disclosure, the message is the message transceived through the mobile communication module using a Short Message Service and a Multimedia Message Service, for example.

Next, in operation S302, position information of a terminal is identified through a position information identifying module. For example, a GPS module is instructed to receive position information corresponding where a terminal is currently located.

Further, as an alternative, the position information may be identified by the mobile communication module (or a sub communication module) by performing an LPS using the intensity of signals received through the mobile communication module (or sub communication module) or by performing a WPS by using the sub communication module, such as a Wireless LAN. Further, as another embodiment, the position information may be identified by identifying a movement or a position of the terminal by using a sensor module (for example, the motion sensor, the gravity sensor, the geomagnetic sensor, and the altitude sensor) included in the terminal and estimating a current position of the terminal.

Further, identification of the position information of the terminal may be configured by selecting any one of the position identification methods or combining two or more of the position identification methods.

Next, in operation S303, a message corresponding to an event generated in operation S301 is stored in such a way that the message is with the position information identified in operation S302.

FIG. 4 is a diagram illustrating an example of a message data format stored by the message processing method according to an embodiment of the present disclosure.

Referring to FIG. 4, message data 400 includes the position information 405 identified in operation S302 of FIG. 3 together with a message identifier 401, a time 402, a transmission/reception identifier (for example, a number of a transmitter or a number of a receiver) 403, and message contents 404 that are generated by the input of the user in operation S301, and then the configured message data 400 is stored.

Referring back to FIG. 3, the message processing method according to the embodiment of the present disclosure further includes determining if a request for displaying the position information of the message at operation S304. If the request for displaying the position information of the message at operation S304 is received, the message processing method combines the message data with map data and displays the combined data at operation S305 according to generation of an event (hereinafter, referred to as a “message position information display event”). The message position information display event may be generated according to a user's input making a request for a display of the position information of the message from a menu item providing a message display UI 501 displaying the message.

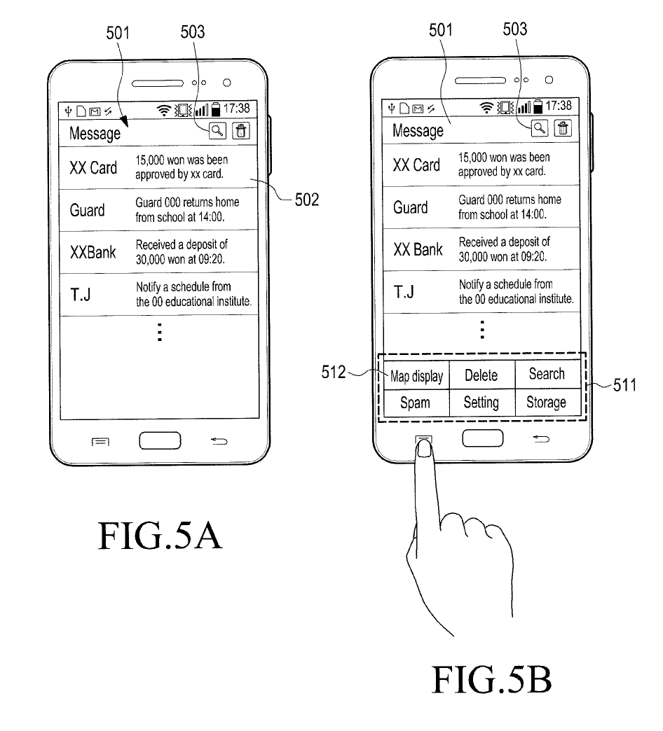

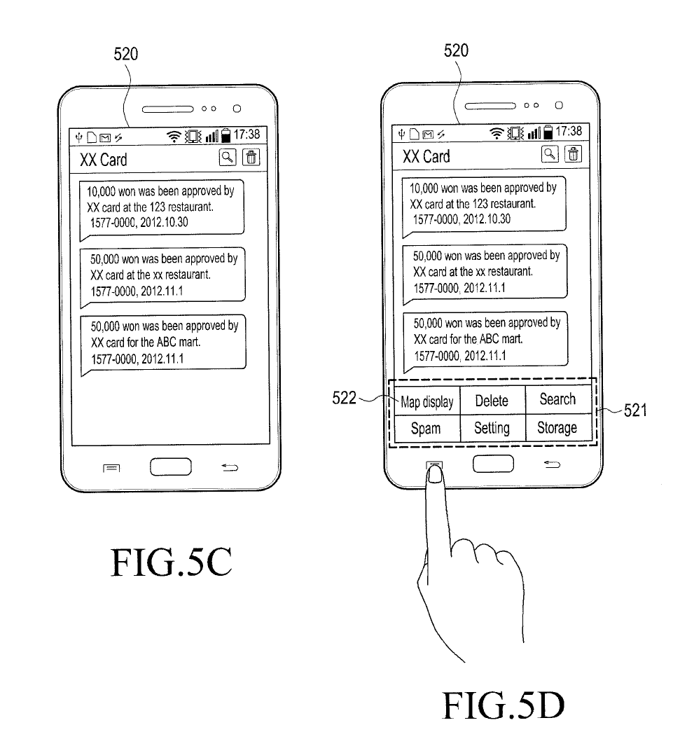

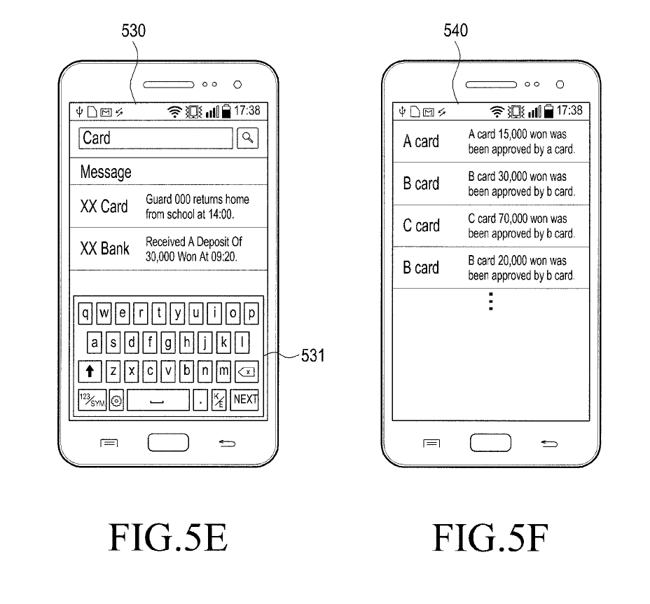

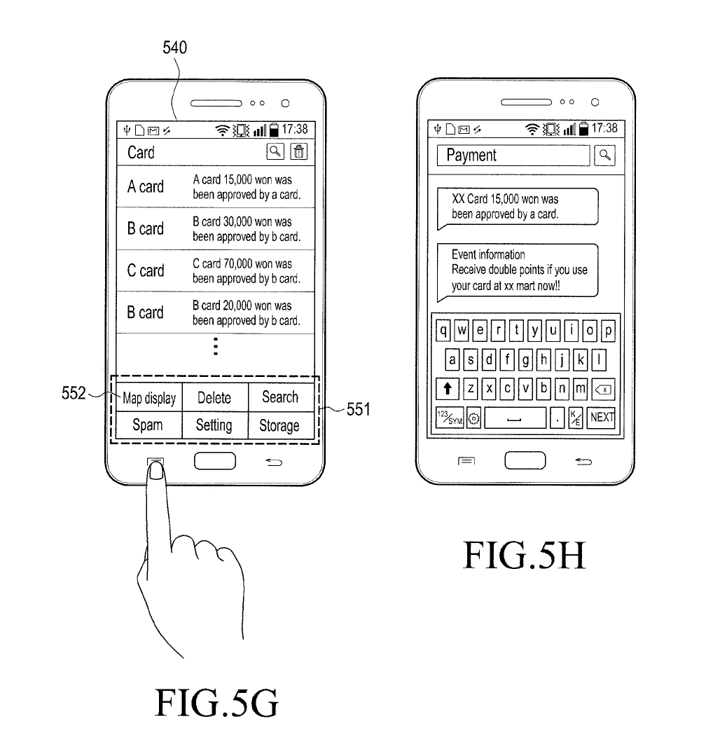

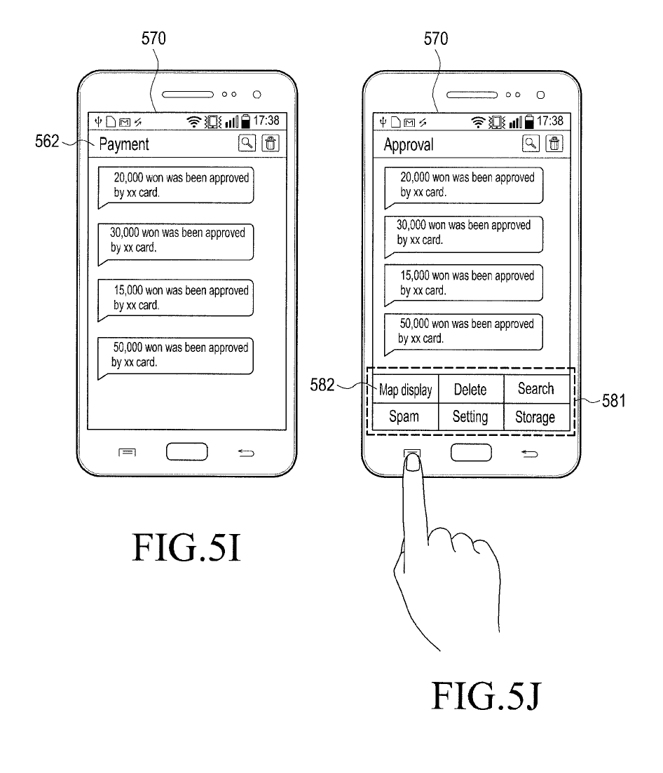

FIGS. 5A, 5B, 5C, 5D, 5E, 5F, 5G, 5H, 5I, 5J, and 5K are diagrams illustrating examples of a user interface provided by the message processing method according to an embodiment of the present disclosure.

Referring to FIGS. 5A and 5B, when an input for requesting activation of a menu item is identified while displaying a main message display UI 501 that classifies a received (and transmitted) message based on a receiver (and transmitter) identifier 502, a menu 511 including at least a map display button 512 is displayed. Further, the message position information display event may be generated according to a selection of a region corresponding to the map display button 512 through an input interface.

Referring to FIGS. 5A, 5C, and 5D, according to an input of a selection of the receiver (and transmitter) identifier 502, a receiver/transmitter based message display UI 520 is displayed for arranging and displaying message contents received (transmitted) by the selected receiver (and transmitter) identifier 502 in an order of time, and the menu 521 including at least the map display button 522 is displayed when the input making the request for activation of the menu item is identified. Further, the message position information display event may be generated according to a selection of a region corresponding to the map display button 522 through an input interface.

Referring to FIGS. 5A, 5E, 5F, 5G and 5K, a search UI 530 for searching may be provided according to a request for searching in the message when the main message display UI 501 is displayed. As illustrated in FIG. 5E, a message including the keyword is searched when a search word (for example, “card”) is input by using a key input unit 531 and request for searching of the search word, for example, the search button 503 is input. A result of the search may be provided as a search result list 540 as illustrated in FIG. 5F, and may be provided in an order of time by classifying the received (and transmitted) message based on the receiver (and transmitter) identifier 502. Further, when the input for activation of the menu is identified when the search result list 540 is displayed, the menu 551 including at least a map display button 552 is displayed as illustrated in FIG. 5G. Further, the message position information display event may be generated according to a selection of a region corresponding to the map display button 552 through a user interface. Further, a message included in the search result list 540 may be displayed together with the map according to the message position information display event as illustrated in FIG. 5K.

Referring to FIGS. 5D, 5H, 5I, 5J and 5K, a search UI 560 for searching may be provided according to a request for searching in the message when the receiver/transmitter based message display UI 520 is displayed. Further, a message corresponding to the keyword when a search word (for example, “approved”) is input in a search word input window 562 and the search button 503 implemented through the GUI or a search button implemented by hardware is input. A result of the search may be provided as a search result list 570 as illustrated in FIG. 5I, and at least one message re-constructed by extracting a message including the keyword may be included in the search result list 570. Further, when the input for activation of the menu is identified when the search result list 570 is displayed as illustrated in FIG. 5J, a menu 581 including at least a map display button 582 is displayed. Further, the message position information display event may be generated in response to a selection of a region corresponding to the map display button 582 through an input interface. Further, a message included in the search result list 570 may be displayed together with the map according to the message position information display event as illustrated in FIG. 5K.

As described above, the transceived message is provided together with the position information so that a position at which the message is transceived may be displayed on the map. In this example, financial information, such as use details of a credit card or a bank statement, is provided in connection with a map, thereby allowing a user may more intuitively identify financial information and more conveniently manage the financial information.

The example in which the user's input making the request for the display of the position information of the message is generated in a state where the main message display UI 510 is provided has been described, but the present disclosure is not limited thereto.

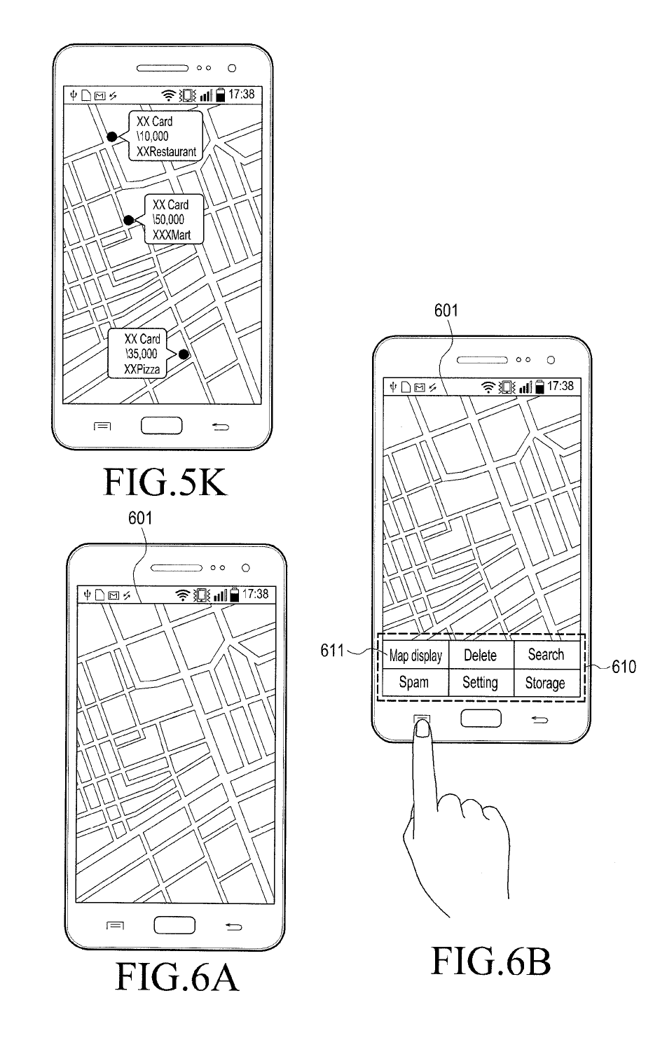

FIGS. 6A and 6B are diagrams illustrating another example of a user interface provided by the message processing method according to the embodiment of the present disclosure.

Referring to FIGS. 6A and 6B, the user's input making the request for the display of the position information of the message may be generated when a map UI 601 is provided. Specifically, when the input making a request for activation of the menu is identified when the map UI 601 is provided, the menu 610 including at least a message display button 611 is displayed. Further, the message position information display event may be generated in response to a selection of a region corresponding to the message display button 611 through an input interface. Further, a message corresponding to a map range provided through the map UI 601 may be displayed with the map according to the generation of the message position information display event.

The input making the request for the activation of the menu may include an input of a menu key button implemented through the GUI displayed on the touch screen, an input of a menu item key button implemented by a hardware in the terminal, an input of a touch of a predetermined region for activation of a menu item, or an input of a predetermined pattern of gesture for activation of a menu item.

According to the present disclosure, it is possible to effectively utilize the transceived message by linking with map services by storing position information of the transceived message.

Furthermore, the disclosure allows a user to more intuitively identify special information by matching position information of a received message with a map and providing the map matched position information for the purpose of providing the special information.

It may be recognized that the various embodiments of the present disclosure may be implemented with hardware, software, or a combination of hardware and software. The predetermined software may be stored in a volatile or nonvolatile storage device, such as ROM, a memory, such as RAM, a memory chip, a device, or an integrated circuit, or a storage medium, such as a CD, a DVD, a magnetic disk, or a magnetic tape, which may optically or magnetically records data and is simultaneously readable by a machine (e.g. a computer). It will be appreciated that the message processing method of the present disclosure may be implemented by a computer or a portable terminal including a controller and a memory, and the memory is one example of a non-transitory machine readable storage medium appropriate for storing a program or programs including instructions implementing the embodiments of the present disclosure. Accordingly, the message processing method of the present disclosure includes a program including a code for implementing an apparatus and a method defined in any claim of the specification, and a machine (a computer, and the like) readable storage medium storing the program.

Further, the portable terminal may receive the program from a program providing device and store the received program. The program providing device may include a program including instructions for performing a predetermined contents protection method, a memory for storing information necessary for the contents protection method, a communication module for performing wired or wireless communication, and a controller for controlling transmission of the program. The program providing device may provide the program to the portable terminal when receiving a request for provision of the program from the portable terminal. Further, the program providing device may be configured to provide the program to the portable terminal even in a case where there is no request for the program from the portable terminal, for example, when the portable terminal is positioned in a specific place.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of processing a text message in a terminal, the method comprising:
receiving a text message;
identifying position information of a terminal in response to the receiving of the text message; and
configuring message data including the text message and the position information and storing the message data.

2. The method of claim 1, further comprising:
displaying map data with a position identifier indicating a position corresponding to the position information and with content of the text message.

3. The method of claim 2, wherein the displaying of the map data includes:
identifying a current position;
detecting a text message corresponding to a predetermined region based on the current position; and
displaying map data of the predetermined region with a position identifier of the detected text message and the content of the text message.

4. The method of claim 1, wherein the displaying of the map data includes:
detecting a text message corresponding to an input of a user; and
displaying the map data, the position identifier corresponding to the detected text message, and the text message.

5. The method of claim 4, wherein the detecting of the text message includes identifying the text message based on a search word input by the user.

6. The method of claim 4, wherein the detecting of the text message includes identifying the text message based on a transmitter of the text message input by the user.

7. The method of claim 4, wherein the detecting of the text message includes identifying the a text message based on time information input by the user.

8. The method of claim 2, wherein the displaying of the map data includes:
extracting a text corresponding to a reference from the text message; and
reconfiguring the extracted text which is the content included in the text message and displaying the reconfigured text in the display.

9. The method of claim 2, further comprising:
receiving a different text message from a different terminal; and
identifying a different position information of the different terminal in response to the receiving of the different text message,
wherein the displaying of the map data includes displaying the different position identifier indicating a different position corresponding to the different position information.

10. The method of claim 2, wherein the text message comprises financial information related to an activity at the position corresponding to the position information.

11. A terminal for use in a wireless communication network, the terminal comprising:
a display;
an input interface;
a GPS receiver;
a communication unit;
a controller configured to execute one or more program modules; and
a memory unit configured to store the one or more program modules,
wherein the one or more program modules process a text message received through the communication unit, identify position information of a terminal in response to the receiving of the text message, and configure message data including the text message and the position information and store the configured message data in the memory unit.

12. The terminal of claim 11, wherein the one or more program modules further display map data on the display with a position identifier indicating a position corresponding to the position information and content of the text message corresponding to the position identifier.

13. A non-transitory computer-readable storage medium storing instructions that, when executed, cause at least one processor to process a text message received through a communication unit, identify position information of a terminal in response to the receiving of the text message, and configure message data including the text message and the position information and store the configured message data in a memory unit.

14. The non-transitory computer-readable storage medium of claim 13, wherein the one or more programs further display map data on a display with a position identifier indicating a position corresponding to the position information and content of the text message corresponding to the position identifier.
